(19) United States
(12) Patent Application Publication
(10) Pub. No.: US 2011/0001773 A1
(43) Pub. Date: Jan. 6, 2011

(54) INK CARTRIDGE AND INKJET PRINTER FOR ACCEPTING SUCH AN INK CARTRIDGE

(75) Inventors: Lucio Bianco, Jona (CH); Daniel Sulser, Wald (CH); Markus Vogel, Niederurnen (CH)

Correspondence Address: MICHAEL BEST & FRIEDRICH LLP, 100 E WISCONSIN AVENUE, Suite 3300, MILWAUKEE, WI, 53202, US

(73) Assignee: PELIKAN HARDCOPY PRODUCTION AG, Egg (CH)

(21) Appl. No.: 12/830,500

(22) Filed: Jul. 6, 2010

(30) Foreign Application Priority Data
Jul. 6, 2009 (DE) 102009026107.9

(51) Int. Cl. B41J 2/195; B41J 2/175

(52) U.S. Cl. 347/7; 347/86

(57) ABSTRACT

An ink cartridge (9; 2) configured to be mounted and demounted from a printer having a fill level detector (7) that includes a light transmitter (20) and a light receiver (21). The ink cartridge includes a fill level detection device (6, 8) that is configured for use with the fill level detector (7) such that when the ink cartridge (9; 2) has been mounted a fill level of the ink cartridge is detectable, and a mounting detection device (3, 4, 4b) which likewise co-operates with the fill level detector (7) of the printer in such a way that the mounting and demounting of the ink cartridge (9; 2) is detectable. The mounting detection device (3, 4, 4b) includes a light beam interruption element (4, 4b) which is mounted so as to be movable relative to the fill level detection device (6; 8) and permits an asymmetric signal sequence on mounting and demounting of the ink cartridge (9; 2).

### RELATED APPLICATION DATA

This application claims priority from German Patent Application No. 10 2009 026 107.9, filed Jul. 6, 2009, the entire contents of which are incorporated by reference herein.

### BACKGROUND

The present invention relates to an ink cartridge, and to a printer, especially an inkjet printer, for use of such an ink cartridge.

Inkjet printers having residual ink detection sensors are generally known. For that purpose, at least a portion of the ink cartridge is transparent or light-permeable. The residual ink detection sensors are generally optical sensors which comprise a light emitter, which emits light, and a light receiver, which receives light that has been emitted by the light emitter and that passes through the ink cartridge or through the transparent portion thereof. In this respect, reference is made, for example, to JP 2-960614 B2. In that prior art it was felt to be a disadvantage that the removal or demounting of an ink cartridge from the printer is not detected by the optical sensors. In particular, it is not ascertained whether or not the ink cartridge has been inserted or mounted in the printer. Malfunctions of the printer can occur as a result.

### SUMMARY

To avoid that disadvantage, DE 60 2005 001 410 T2=EP 1 570 994 B1 proposes the provision of an ink cartridge having a first detection zone for the fill level thereof and a second detection zone for ascertaining the mounting or demounting of the ink cartridge, both detection zones being detected by the same detector arranged on the printer, which detector comprises a light beam sensor and a light beam receiver. In that arrangement, on demounting of the cartridge, merely a signal reversal in relation to the mounting of the printer cartridge is effected. That arrangement does not provide recognition in every case of whether an interruption of the signal has been triggered by mounting or demounting of a printer cartridge. That is the starting point for the present invention. That is to say, it is necessary to develop a system which enables the mounting of a printer cartridge to be clearly distinguished from the demounting thereof.

One aspect of the present invention therefore lies in taking measures that permit any desired signal sequence, especially an asymmetric signal sequence, on mounting and demounting of an ink cartridge. As a result, the mounting of an ink cartridge can be clearly distinguished from the demounting thereof. The simplest kind of asymmetry is that, for example, a light beam interruption signal is triggered when an ink cartridge is mounted, while no signal is triggered when the ink cartridge is demounted or removed from the printer or the cartridge holder. It is conceivable, however, for a signal to be given on mounting, while two or three signals are triggered on demounting. The crucial factor is therefore the asymmetry of the signals on mounting on the one hand and on demounting on the other hand.

In order to achieve the above-mentioned aim it is in any case necessary for the ink cartridge to have a mounting detection device having a light beam interruption element mounted so as to be movable relative to the ink cartridge, especially relative to the fill level detection device.

In a further advantageous embodiment, the mentioned light beam interruption element is carried along by a driver element, especially in the form of a tappet or the like, which is operative on mounting or demounting of the ink cartridge and is likewise mounted so as to be movable relative to the ink cartridge, the carrying-along of the light beam interruption element in each case being effected after a time delay relative to the movement of the driver element or tappet.

It is accordingly possible, for example, for the driving of the light beam interruption element to be effected in such a way that, on mounting or demounting of the ink cartridge, the associated light beam detector, usually a fill level detector, in each case generates a different number of signals, especially only one signal on mounting but not on demounting of the ink cartridge.

In a preferred embodiment, on mounting of the ink cartridge the driver element, especially in the form of a tappet, is movable into the ink cartridge or into a housing defining the ink cartridge against the action of a resilient element, especially a compression spring. As a result of that movement, after a predetermined travel distance the light beam interruption element is driven or carried along, this being effected over a second predetermined travel distance. On so doing, a light-impermeable part associated with the light beam interruption element interrupts the beam path between the light beam transmitter and the light beam receiver, with the result that a corresponding “mounting” signal is triggered. On demounting of the ink cartridge, in turn a delayed co-movement of the light beam interruption element into the starting position takes place, with the result that on demounting of the ink cartridge the beam path between the light beam transmitter and the light beam receiver is not inter-rupted and accordingly no signal is generated. The asymmetry of the signal sequence desired above is thus achieved.

The light-impermeable part of the light beam interruption element is preferably in the form of a projection or tab.

In a preferred embodiment, the light beam interruption element is formed by a longitudinally displaceably mounted strip element having a tab which, on mounting of the cartridge, is movable through the light beam of the fill level detector.

In a specific embodiment, the above-mentioned driver element, in the form of a tappet, is mounted so as to be longitudinally displaceable parallel to the mentioned strip element of the light beam interruption element. Furthermore, that driver element preferably has a projection which engages in a longitudinal groove in the strip element or vice versa, the length of the longitudinal groove defining the first travel distance over which the light beam interruption element is not driven or carried along. The subsequent displacement path of the strip element including the tab, i.e. the light beam interruption element, defines the second travel distance over which, on mounting of the ink cartridge, the light-impermeable part of the light beam interruption element moves through the beam path of the fill level detector and generates the “mounting” signal already mentioned.

In a further preferred embodiment of the ink cartridge, the fill level detection device comprises a prismatically constructed reflector and, associated therewith and spaced apart therefrom, a deflecting prism outside or inside the housing, which deflecting prism comes into contact with ink as long as the fill level of the cartridge is still sufficient. In the operating position, that is to say after mounting of the ink cartridge, the prism surfaces of the reflector are located between the light beam transmitter and the light beam receiver of the fill level detector.

Advantageously, on mounting of the ink cartridge the driver element or tappet is arranged to be acted upon by a projection on the printer or on an ink cartridge holder, especially by a part of the fill level detector, in such a way that it covers first the first travel distance and then the second travel distance, the light beam interruption element being driven by the tappet in the case of the second travel distance.

It should also be mentioned at this point that a cartridge that brings about signal generation by combining a signal, i.e. a signal generated by the tappet at the same detector or by another interrupter at a different detector, with the “asymmetric” signal generated by the described invention may also be expedient in certain cases.

Preferred embodiments of an ink cartridge constructed in accordance with the invention are described in greater detail below with reference to the accompanying drawings.

### BRIEF DESCRIPTION OF THE DRAWINGS

FIG. 1 is a side view of a first embodiment of an ink cartridge constructed in accordance with the invention;

FIG. 2 shows the ink cartridge according to FIG. 1 in section along line II-II;

FIG. 3 is a perspective view of the ink cartridge according to FIGS. 1 and 2, seen obliquely from the front and above;

FIG. 4a shows the ink cartridge corresponding to FIG. 1 at the beginning of mounting in the printer or in a cartridge holder (starting position);

FIG. 4b shows the ink cartridge according to FIG. 1 in an Intermediate mounting position;

FIG. 4c shows the ink cartridge according to FIG. 1 in the mounted operating\position (end position);

FIG. 5 shows an embodiment of a fill level detection device, as used in the embodiment of an ink cartridge according to FIGS. 1 to 4, more specifically in a diagrammatic front view showing on one side the beam path when the ink cartridge is sufficiently full and on the other side the beam path when the ink cartridge is empty; and

FIG. 6 shows a diagrammatic side view, partly in longitudinal section, of a second embodiment of an ink cartridge constructed in accordance with the invention, more specifically a so-called “top-loader” cartridge.

### DETAILED DESCRIPTION

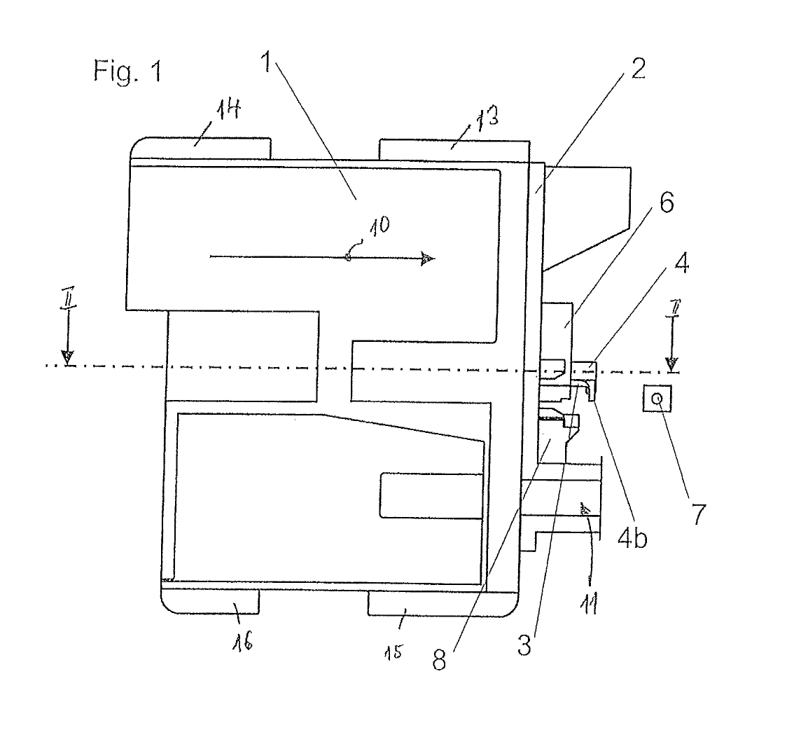

FIGS. 1 to 3 show an ink cartridge 9, more specifically a so-called “front loader” cartridge, on the front face of which in the direction of mounting in accordance with arrow 10 in FIG. 1 there are arranged the ink outlet 11 and a fill level detection device 6, 8. The two afore-mentioned parts are part of a cover 12 defining the front face. On the upper face and the bottom face of the cartridge there are formed longitudinal guide ribs 13, 14, 15 and 16. The ink cartridge 9 is otherwise defined by an ink container 1 of shallow parallelepipedal outline which bounds an ink receiving space.

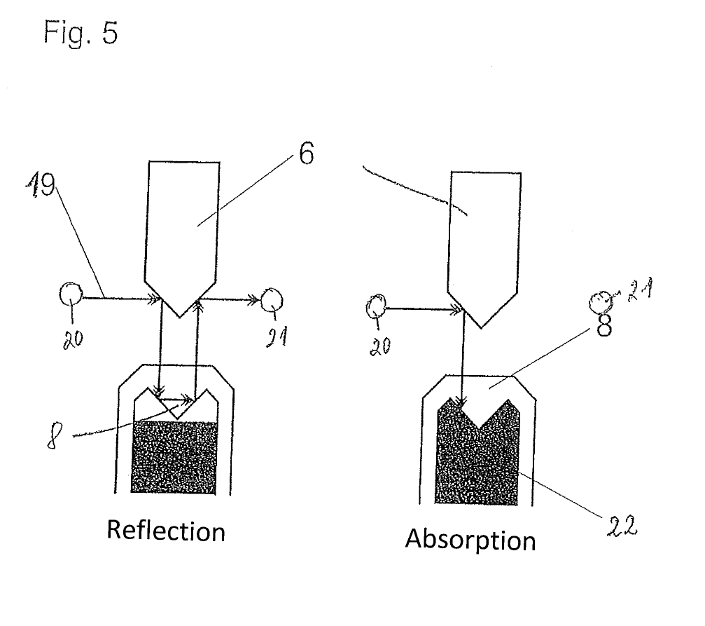

In the embodiment shown, the fill level detection device comprises a prismatically constructed reflector 6 and, arranged therebelow and spaced apart therefrom, a deflecting prism 8 which comes into contact with ink inside the container as long as the fill level of the cartridge is still sufficient. Such a fill level detection device is shown diagrammatically in FIG. 5, more specifically in a diagrammatic front view showing the beam path 19 between a light emitter or light transmitter 20 and a light receiver 21. If, as shown on the right in FIG. 5, there is sufficient ink in the ink container 1, the side of the deflecting prism 8 inside the container is wetted with ink. The light beam deflected by the reflector 6 is then substantially absorbed in the ink. In FIG. 5 the ink is indicated by reference numeral 22. As soon as the ink cartridge has been emptied to such an extent that the ink no longer wets the deflecting prism 8, the light beam 19 emitted by the light transmitter 20 is fully reflected, in accordance with the illustration on the left in FIG. 5, so that it is received by the light receiver 21. The corresponding signal indicates that the ink cartridge needs to be exchanged, i.e. replaced by a full cartridge.

The light transmitter 20 and the light receiver 21 define a fill level detector 7 arranged on the printer in accordance with FIGS. 1 to 4. When the ink cartridge 9 has been mounted or inserted, the fill level thereof can be detected therewith.

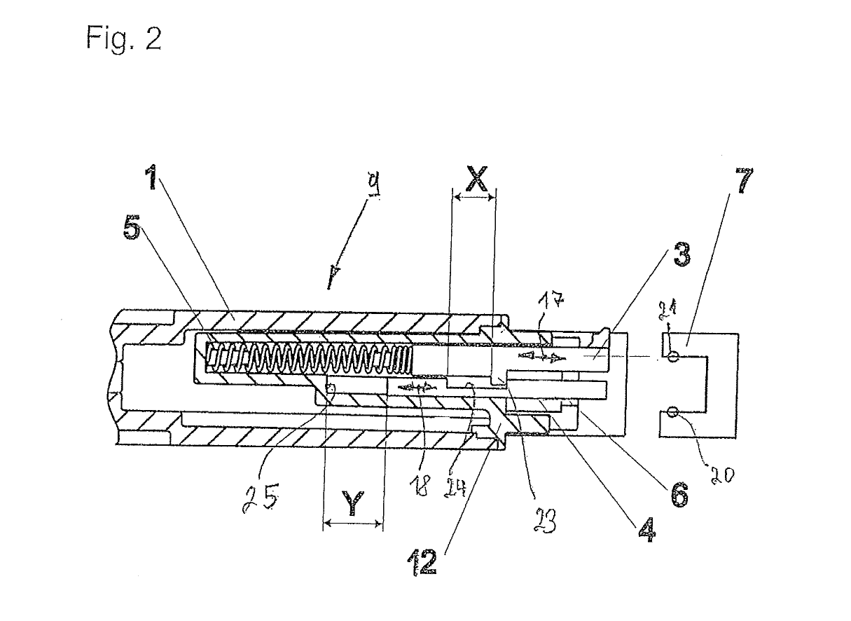

As already mentioned, the ink cartridge 9 also has on its front face a mounting detection device 3, 4, 4b, which in the present case likewise co-operates with the fill level detector 7 and in such a way that mounting and/or demounting of the ink cartridge 9 is detectable. The mounting detection device has specifically a light beam interruption element 4, 4b, which is mounted so as to be movable relative to the ink cartridge 9, and in this instance relative to the fill level detection device 6, 8, and which permits an asymmetric signal sequence on mounting and demounting of the ink cartridge 9. In accordance with FIG. 2, the light beam interruption element 4, 4b is coupled to a driver element in the form of a tappet 3 movable in parallel, that is to say mounted so as to be longitudinally displaceable. The light beam interruption element 4, 4b and the tappet 3 are mounted above the two prism surfaces of the reflector 6 so as to be longitudinally displaceable inside the latter and inside the ink container 1, more specifically in the direction perpendicular to the front face defined by the cover 12. That longitudinal displaceability is indicated in FIG. 2 by the double-headed arrows 17 and 18.

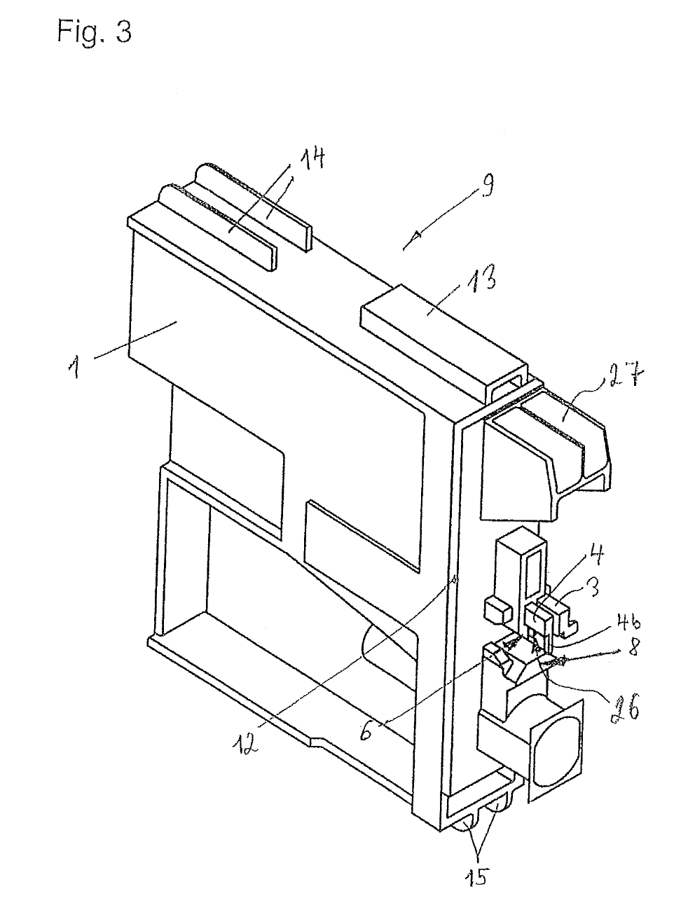

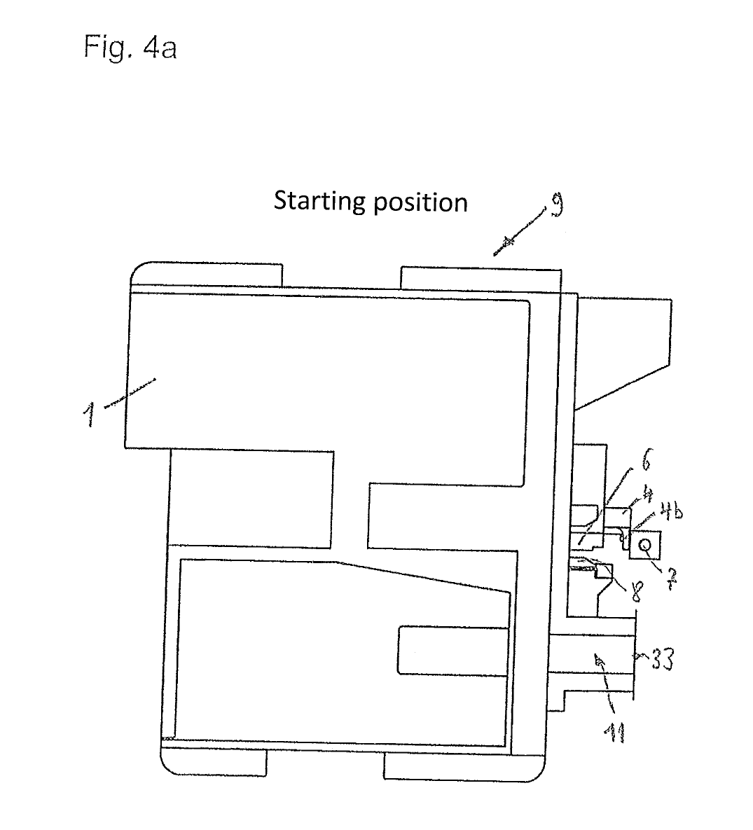

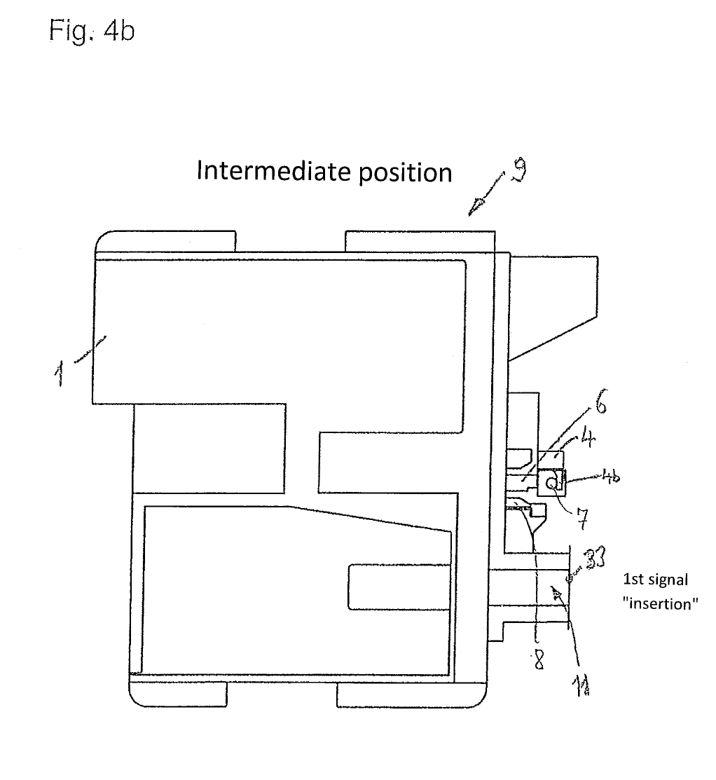

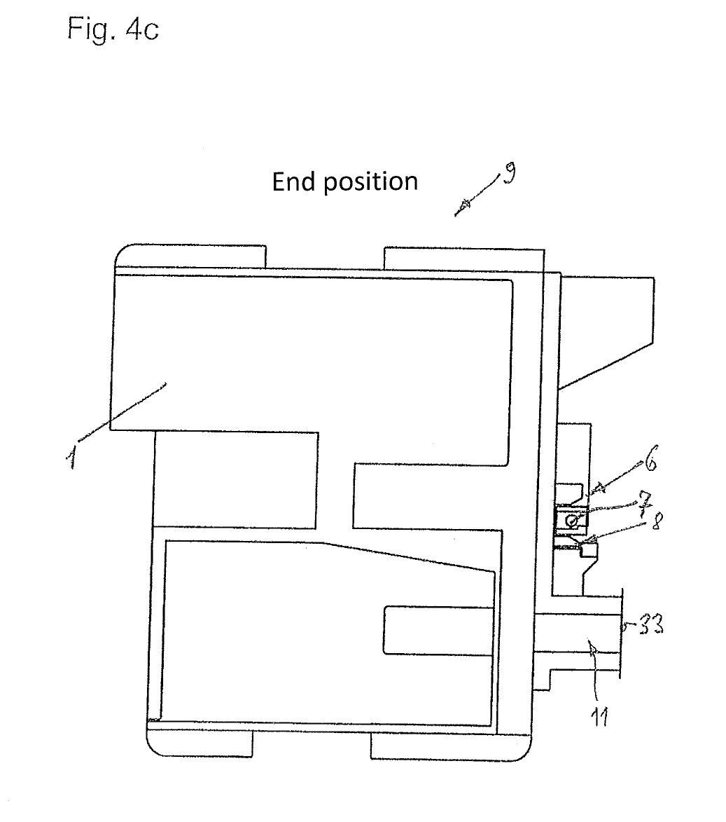

On mounting of the ink cartridge 9 in the printer or an associated cartridge holder, the tappet 3 is acted upon by the side of the detector 7 that faces it and is moved against the action of a compression spring 5 into the interior of the ink container 1 by a first travel distance “X” (see FIG. 2). The tappet 3 has a projection 23 which projects into a facing longitudinal groove 24 of the light beam interruption element 4. Once the tappet 3 has covered the travel distance “X”, by means of the projection 23 the light beam interruption element 4, 4b is driven or carried along by the tappet 3 as far as the stop 25 for the light beam interruption element 4, 4b inside the housing. As a result, a second travel distance “Y” of the light beam interruption element 4, 4b is defined. Once both travel distances have been covered, the ink cartridge 9 is located in the operating-end position in accordance with FIG. 4c. FIG. 4a shows the starting position for mounting of the ink cartridge 9. FIG. 4b shows an intermediate position in which the tappet 3 has covered the travel distance “X” and is engaging the light beam interruption element 4, 4b for driving. In this position a mounting signal has not yet been generated because the light-impermeable part 4b of the light beam interruption element has not yet interrupted the beam path 19 of the fill level detector. The light-impermeable part 4b of the light beam interruption element is in the form of a downwardly extending tab. In the inter-mediate position according to FIG. 4b, the tab has therefore not yet moved through the mentioned beam path. Only when the tab 4b has moved through the beam path of the fill level detector 7 is a signal generated indicating that the ink cartridge is being mounted or inserted. When the ink cartridge is then located in the operating-end position according to FIG. 4c, the light beam interruption element 4, 4b has moved into the ink container 1 to such an extent that the light-impermeable tab 4b is no longer visible. The tab is then located inside the housing of the reflector 6, which housing projects beyond the front face of the ink cartridge, behind the prism surface associated with the light sensor. For that purpose, between the two prism surfaces of the reflector 6 there is a receiving slot 26 into which the tab 4b has been moved when the cartridge is in the mounted position. The receiving slot in question can be seen in FIG. 3.

When the ink cartridge 9 is then removed again from the position according to FIG. 4c, first of all the tappet 3 moves by travel distance “X” out of the ink container 1 again. The fill level detection device 6, 8 of the ink cartridge is then already located outside the beam path 19 of the fill level detector 7 again. When the ink cartridge is moved further out of the associated cartridge holder, the light beam interruption element 4 is then carried along by the tappet 3 and likewise withdrawn from the ink container 1 again into a position in accordance with FIGS. 1 to 3. On demounting, as a result of the circumstances described, no signal, that is to say no light beam interruption signal, is generated. Such a signal is produced only on mounting of the ink cartridge 9. Such signal asymmetry allows mounting and demounting of the ink cartridge to be distinguished very precisely.

Depending upon the geometry of the light-impermeable part of the light beam interruption element, the signal sequence can differ from that described above.

It should also be mentioned at this point that the light beam interruption element comprises a strip element 4 which is mounted so as to be longitudinally displaceable in the ink container and has a light-impermeable part in the form of a downwardly extending tab 4b. The strip element 4 is displaceable parallel to the tappet 3.

The displacement space for the tappet 3 and the strip element 4 including the tab 4b is preferably likewise part of the cover 12, as can be seen in FIG. 2. All the functional elements of the ink cartridge are therefore part of the cover 12. This has production-related advantages, because the remainder of the ink container can then likewise be produced relatively simply. An ink cartridge 9 so constructed preferably consists of plastics material which can be either transparent or light-impermeable.

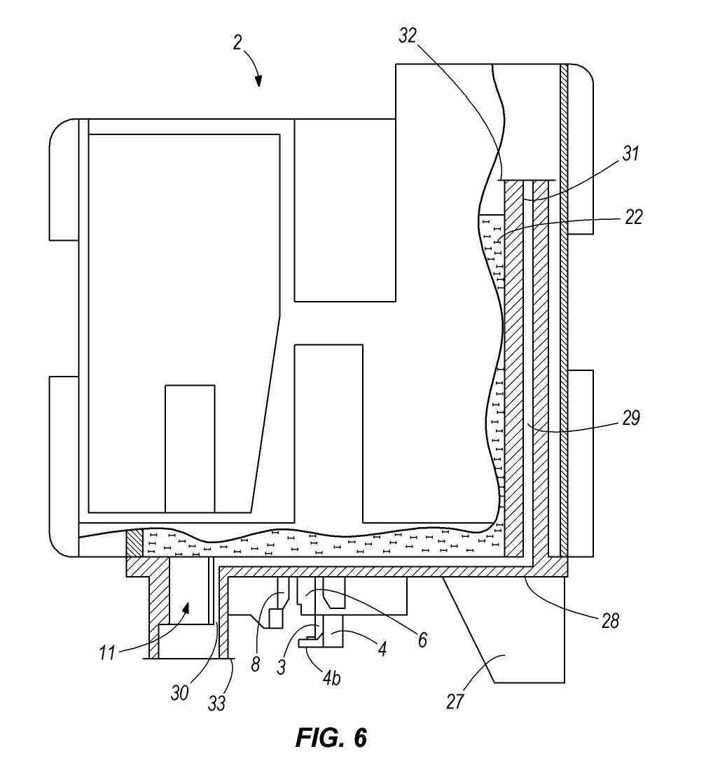

It is, of course, also possible for a so-called “top loader” cartridge 2 according to FIG. 6 to be constructed in the same way. In such a cartridge, the above-mentioned device for ascertaining mounting or demounting is located on the bottom face of the cartridge. In the embodiment according to FIG. 6, all the functional features, as described above as part of the front face of the cartridge, are part of the base, which is in the form of a base cover 28. Integrated in that base cover 28 is an air-admission channel 29, the inlet 30 of which is arranged in the region of the ink outlet 11. The air outlet 31 opens into the ink receiving space above the level of the ink, the air outlet 31 being closed by an air-permeable but fluid-impermeable membrane 32. This has the result that when the ink cartridge is in use the necessary pressure equalization in the interior of the ink cartridge or in the ink receiving space is ensured by the channel 29, without there being any risk of ink escaping through the air-admission channel 29 and air inlet 30.

The ink outlet 11 is also closed by a sealing film 33, which is either removed or simply pierced before use, i.e. on first use, this being effected by means of an ink supply needle associated with the printer.

The ink inside the ink receiving space or the ink cartridge 2 is indicated by reference numeral 22 in FIG. 6.

The invention relates also to a printer, especially an inkjet printer, having a holder for an ink cartridge of the kind described above. If the printer is a printer having a separate cartridge holder, the invention relates also to such a cartridge holder. In both cases there is associated with the receiving space for the ink cartridge a fill level detector 7, into the beam path 19 of which a fill level detection device and a mount-ing detection device of the described kind is arranged to project on mounting of an ink cartridge 9 or 2. Accordingly, the interfaces between the cartridge and the cartridge holder are of complementary construction, and that is the case irrespective of whether a “front-loader” version or a “top-loader” version is involved.

Both embodiments of an ink cartridge 9 and 2 also have on their functional element faces (front face and bottom face, respectively) separate guide elements 27 which improve alignment during mounting or demounting of the ink cartridge.

All the features disclosed in the application documents are claimed as being important to the invention to the extent that they are novel individually or in combination with respect to the prior art.

1-12. (canceled)

13. An ink cartridge (9; 2) configured to be mounted and demounted from a printer having a fill level detector (7) that includes a light transmitter (20) and a light receiver (21), the ink cartridge comprising:
a fill level detection device (6, 8) that is configured for use with the fill level detector (7) such that when the ink cartridge (9; 2) has been mounted, a fill level of the ink cartridge is detectable; and
a mounting detection device (3, 4, 4b) which likewise co-operates with the fill level detector (7) of the printer in such a way that the mounting and demounting of the ink cartridge (9; 2) is detectable,
wherein the mounting detection device (3, 4, 4b) includes a light beam interruption element (4, 4b) which is mounted so as to be movable relative to the fill level detection device (6; 8) and permits an asymmetric signal sequence on mounting and demounting of the ink cartridge (9; 2).

14. The ink cartridge according to claim 13, wherein the ink cartridge includes a tappet (3), wherein the light beam interruption element (4, 4b) is coupled to the tappet (3) for movement with the tappet (3), wherein the tappet (3) is operative on mounting and demounting of the ink cartridge (9; 2) from the printer, wherein the tappet is mounted so as to be movable relative to the ink cartridge, wherein movement of the light beam interruption element upon mounting and demounting is effected after a time delay relative to the movement of the tappet (3).

15. The ink cartridge according to claim 14, wherein driving of the light beam interruption element (4, 4b) is effected in such a way that, on mounting and demounting of the ink cartridge from the printer, the associated fill level detector (7) in mounting and demounting generates a different number of interruption signals.

16. The ink cartridge according to claim 15, wherein the associated fill level detector (7) in mounting and demounting generates only one signal on mounting but not on demounting of the ink cartridge.

17. The ink cartridge according to claims 14, wherein on mounting of the ink cartridge (9; 2) to the printer the tappet (3) is movable into a container (1) defining the ink cartridge against the action of a resilient element.

18. The ink cartridge according to claim 17, wherein the resilient element includes a compression spring 5.

19. The ink cartridge according to claim 17, wherein the tappet (3) projects beyond a front face of the container located in a mounting direction of a front-loader ink cartridge (9), wherein on mounting of the ink cartridge the tappet is arranged to be pressed into the container (1) against the action of the resilient element, wherein after a first travel distance (X), the tappet (3) drives the light beam interruption element (4, 4b) over a predetermined second travel distance (Y).

20. The ink cartridge according to claim 17, wherein the tappet (3) projects beyond a base cover (28) of the container in a mounting direction of a top-loader ink cartridge (2), wherein on mounting of the ink cartridge the tappet is arranged to be pressed into the container (1) against the action of the resilient element, wherein after a first travel distance (X), the tappet (3) drives the light beam interruption element (4, 4b) over a predetermined second travel distance (Y).

21. The ink cartridge according to claim 13, wherein the light beam interruption element (4, 4b) includes a light-impermeable tab (4b) which, at least on mounting of the ink cartridge (9; 2), is movable through a light beam (19) of the associated fill level detector (7).

22. The ink cartridge according to claim 13, wherein the light beam interruption element (4, 4b) is formed by a longitudinally displaceably mounted strip element (4) having a tab (4b) which, on mounting of the ink cartridge, is movable through a light beam of the fill level detector (7).

23. The ink cartridge according to claim 17, wherein the light beam interruption element (4, 4b) is formed by a longitudinally displaceably mounted strip element (4) having a tab (4b) which, on mounting of the ink cartridge, is movable through a light beam of the fill level detector (7), wherein the tappet (3) projects beyond a face of the container located in a mounting direction, wherein on mounting of the ink cartridge the tappet is arranged to be pressed into the container (1) against the action of the resilient element, wherein after a first travel distance (X), the tappet (3) drives the light beam interruption element (4, 4b) over a predetermined second travel distance (Y), wherein the tappet (3) is mounted so as to be longitudinally displaceable parallel to the strip element (4) of the light beam interruption element and has a projection (23) which engages in a longitudinal groove (24) of the strip element (4), wherein the length of the longitudinal groove (24) determines the first travel distance (X) of the tappet (3), and wherein a displacement path of the strip element (4) including the tab (4b) as far as a stop (25) inside the container determines the second travel distance (Y).

24. The ink cartridge according to claim 13, wherein the ink cartridge includes a housing, wherein the fill level detection device includes a prismatically constructed reflector (6) and, associated therewith and spaced apart therefrom, a deflecting prism (8) at least one of outside and inside the housing, which deflecting prism comes into contact with ink as long as the fill level of the ink cartridge is still sufficient.

25. The ink cartridge according to claim 24, wherein in an operating position, that is to say after mounting of the ink cartridge (9; 2), prism surfaces of the reflector (6) are located between the light transmitter (20) and the light receiver (21) of the fill level detector (7), and wherein on mounting and demounting of the ink cartridge a light-impermeable part of the light beam interruption element (4, 4b), is movable through a beam path (19) between the light transmitter (20) and the light receiver (21).

26. The ink cartridge according to claim 14, wherein on mounting of the ink cartridge, the tappet (3) is configured to be acted upon by a projection of the fill level detector (7).

27. An inkjet printer comprising:
a holder;
an ink cartridge configured to be mounted to the holder and demounted from the holder; and
a fill level detector (7) that includes a light receiver (21) and a light transmitter (20) operable to generate a light beam path (19), the ink cartridge including,
a fill level detection device (6, 8) for use with the fill level detector (7) such that when the ink cartridge (9; 2) has been mounted to the holder a fill level of the ink cartridge is detectable; and
a mounting detection device (3, 4, 4b) which likewise co-operates with the fill level detector (7) of the printer in such a way that the mounting and demounting of the ink cartridge (9; 2) is detectable,
wherein the fill level detection device (6,8) and the mounting detection device (3, 4, 4b) project into the light beam path (19) on mounting of the ink cartridge in the holder, and
wherein the mounting detection device (3, 4, 4b) includes a light beam interruption element (4, 4b) which is mounted so as to be movable relative to the fill level detection device (6; 8) and permits an asymmetric signal sequence on mounting and demounting of the ink cartridge (9; 2).

28. The inkjet printer according to claim 27, wherein the ink cartridge includes a tappet (3), wherein the light beam interruption element (4, 4b) is coupled to the tappet (3) for movement with the tappet (3), wherein the tappet (3) is operative on mounting and demounting of the ink cartridge (9; 2) from the holder, wherein the tappet is mounted so as to be movable relative to the ink cartridge, wherein movement of the light beam interruption element upon mounting and demounting is effected after a time delay relative to the movement of the tappet (3).

29. The inkjet printer according to claim 28, wherein driving of the light beam interruption element (4, 4b) is effected in such a way that, on mounting and demounting of the ink cartridge from the holder, the associated fill level detector (7) in mounting and demounting generates a different number of interruption signals.

30. The inkjet printer according to claim 29, wherein the associated fill level detector (7) in mounting and demounting generates only one signal on mounting but not on demounting of the ink cartridge.

31. The inkjet printer according to claims 28, wherein on mounting of the ink cartridge (9; 2) to the holder, the tappet (3) is movable into a container (1) defining the ink cartridge against the action of a resilient element.

32. The inkjet printer according to claim 31, wherein the tappet (3) projects beyond a front face of the container located in a mounting direction of a front-loader ink cartridge (9), wherein on mounting of the ink cartridge the tappet is arranged to be pressed into the container (1) against the action of the resilient element, wherein after a first travel distance (X), the tappet (3) drives the light beam interruption element (4, 4b) over a predetermined second travel distance (Y).

33. The inkjet printer according to claim 31, wherein the tappet (3) projects beyond a base cover (28) of the container in a mounting direction of a top-loader ink cartridge (2), wherein on mounting of the ink cartridge the tappet is arranged to be pressed into the container (1) against the action of the resilient element, wherein after a first travel distance (X), the tappet (3) drives the light beam interruption element (4, 4b) over a predetermined second travel distance (Y).

34. The inkjet printer according to claim 27, wherein the light beam interruption element (4, 4b) includes a light-impermeable tab (4b) which, at least on mounting of the ink cartridge (9; 2), is movable through the light beam path (19).

35. The inkjet printer according to claim 27, wherein the light beam interruption element (4, 4b) is formed by a longitudinally displaceably mounted strip element (4) having a tab (4b) which, on mounting of the ink cartridge, is movable through the light beam path of the fill level detector (7).

36. The inkjet printer according to claim 31, wherein the light beam interruption element (4, 4b) is formed by a longitudinally displaceably mounted strip element (4) having a tab (4b) which, on mounting of the ink cartridge, is movable through the light beam of the fill level detector (7), wherein the tappet (3) projects beyond a face of the container located in a mounting direction, wherein on mounting of the ink cartridge the tappet is arranged to be pressed into the container (1) against the action of the resilient element, wherein after a first travel distance (X), the tappet (3) drives the light beam interruption element (4, 4b) over a predetermined second travel distance (Y), wherein the tappet (3) is mounted so as to be longitudinally displaceable parallel to the strip element (4) of the light beam interruption element and has a projection (23) which engages in a longitudinal groove (24) of the strip element (4), wherein the length of the longitudinal groove (24) determines the first travel distance (X) of the tappet (3), and wherein a displacement path of the strip element (4) including the tab (4b) as far as a stop (25) inside the container determines the second travel distance (Y).

37. The inkjet printer according to claim 27, wherein the ink cartridge includes a housing, wherein the fill level detection device includes a prismatically constructed reflector (6) and, associated therewith and spaced apart therefrom, a deflecting prism (8) at least one of outside and inside the housing, which deflecting prism comes into contact with ink as long as the fill level of the ink cartridge is still sufficient.

38. The inkjet printer according to claim 37, wherein in an operating position, that is to say after mounting of the ink cartridge (9; 2), prism surfaces of the reflector (6) are located between the light transmitter (20) and the light receiver (21) of the fill level detector (7), and wherein on mounting and demounting of the ink cartridge a light-impermeable part of the light beam interruption element (4, 4b), is movable through the beam path (19) between the light transmitter (20) and the light receiver (21).

39. The inkjet printer according to claim 28, wherein on mounting of the ink cartridge, the tappet (3) is configured to be acted upon by a projection of the fill level detector (7).
